(19) United States
(12) Patent Application Publication
(10) Pub. No.: US 2006/0245752 A1
(43) Pub. Date: Nov. 2, 2006

(54) Diaphragm device, lens assembly including same and surveillance camera

(76) Inventor: Koji Kawaguchi, Saitama-Shi (JP)

Correspondence Address: JACOBSON HOLMAN PLLC, 400 SEVENTH STREET N.W., SUITE 600, WASHINGTON, DC, 20004, US

(21) Appl. No.: 11/115,337

(22) Filed: Apr. 27, 2005

(51) Int. Cl. G03B 9/08

(52) U.S. Cl. 396/451

(57) ABSTRACT

A lens assembly with a compact diaphragm device incorporated therein, the diaphragm device having an operating member which does not extend beyond the contour of a lens barrel, and a surveillance camera having such a lens assembly are disclosed. The surveillance camera 100 comprises an image pickup lens 104 and a camera main unit 102. The image pickup lens 104 includes a diaphragm device 126. The diaphragm device 126 comprises an upper diaphragm blade 210 having an aperture opening, a lower diaphragm blade having an aperture opening, a support frame 230 for supporting the upper and lower diaphragm blades for rectilinear movement thereof, and a diaphragm blade interlocking plate 240 supported for rotation relative to the support frame 230 and adapted to allow the upper diaphragm blade 210 to move rectilinearly in a first direction while permitting the lower diaphragm blade 220 to move rectilinearly in a second direction different from the first direction. The diaphragm blade interlocking member 240 has a center of rotation located within an aperture area defined by the upper and lower diaphragm blade openings at full aperture.

### BACKGROUND OF THE INVENTION

1. Field of the Invention

The present invention relates to a diaphragm device including rectilinearly movable diaphragm blades, a lens assembly having such a diaphragm device and a surveillance camera having such a lens assembly. Particularly, the present invention relates to a lens assembly with a compact diaphragm device incorporated therein, the diaphragm device having an operating or driving portion which does not extend beyond the contour of the lens barrel, and a surveillance camera having such a lens assembly. Furthermore, the present invention relates to such a compact diaphragm device including rectilinearly movable diaphragm blades.

2. Background Art

A manually operated diaphragm device of the prior art comprises a holding frame including an insert member adapted to be inserted into a lens barrel in its diametrical direction and having an opening, and an extended portion integrally formed with the insert member that has a mounting lug disposed outside the lens barrel; two diaphragm blades slidably disposed within the holding frame; a supporting portion having a hole which extends through the extended portion and being disposed correspondingly opposite the hole and; a rotatable shaft having one of ends extending through the hole in the extended portion and the other end journalled in the supporting portion; an operating lever disposed on the side of the support member and projecting outwardly from the rotatable shaft for rotational movement therearound; and a rotatable boss member disposed within the extended portion and matingly connected at one end to the rotary shaft, the rotatable boss member being arranged to move the two diaphragm blades slidably in the opposite directions. (e.g., see Japanese Patent Laid-Open Application No. 2000-214369 (pages 3-5, FIGS. 1 and 2) which will be referred to as “Document 1”). The arrangement of the manually operated diaphragm device is such that it can be post-installed into the lens barrel. This diaphragm device is relatively simple in structure.

However, the manually operated diaphragm device of the prior art as disclosed in the Document 1 presents a problem in that the fact that the rotation center of the operating portion (or the driving portion) is positioned outwardly of and spaced away from the diaphragm blades would contribute to increased size of the diaphragm device. The manually operated diaphragm device of the prior art also creates another problem in that the operating portion (or the driving portion) may extend beyond the contour of the lens barrel. Therefore, the use of the manually operated diaphragm device of the prior art makes it difficult to downsize an exposure control unit, lens assembly and image pickup device.

It is therefore the object of the present invention is to provide a lens assembly with incorporated therein a diaphragm device including rectilinearly movable diaphragm blades and a surveillance camera having such a lens assembly, which can realize a construction wherein an operating (driving) member does not extend beyond the contour of the lens barrel.

It is a further object of the present invention is to provide a diaphragm device including rectilinearly movable diaphragm blades and having an operating (driving) member of reduced size.

### SUMMARY OF THE INVENTION

The present invention provides a surveillance camera including a diaphragm device including rectilinearly movable diaphragm blades, said surveillance camera comprising: an image pickup lens assembly for focusing a light beam originating from subject; a camera main unit for recording the light beam from the subject passing through said image pickup lens assembly; the diaphragm device for adjusting an amount of light at which the light beam passes through said image pickup lens assembly. This diaphragm device comprising: a first diaphragm blade having an opening defining a first aperture operable on one hand to adjust an amount of light at which the light beam passes through said image pickup lens assembly; a second diaphragm blade having an opening defining a second aperture operable on the other hand to adjust an amount of light at which the light beam passes through said image pickup lens assembly; a support member for supporting said first and second diaphragm blades for rectilinear movement thereof, and; a diaphragm blade interlocking member supported for rotation relative to said support member and adapted to allow said first diaphragm blade to move rectilinearly in a first direction while permitting said second diaphragm blade to move rectilinearly in a second direction different from said first direction.

In the surveillance camera of the present invention, said diaphragm blade interlocking member has a center of rotation located within an aperture area defined by said first and second diaphragm blade openings at full aperture. Also, said diaphragm blade interlocking member can have a center of rotation located on an optical axis of lens system forming said image pickup lens assembly. With this arrangement, it is possible that the operating or driving portion for operating the diaphragm device does not extend beyond the contour of the lens barrel.

The present invention also provides a lens assembly comprising a diaphragm device including rectilinearly movable diaphragm blades, said diaphragm device comprising: a lens system arranged to cause a light beam passing through said lens system to diverge or converge; and the diaphragm device for adjusting an amount of light at which the light beam passes through said image pickup lens assembly, comprising: a first diaphragm blade having an opening defining a first aperture operable on one hand to adjust an amount of light at which the light beam passes through said image pickup lens assembly; a second diaphragm blade having an opening defining a second aperture operable on the other hand to adjust an amount of light at which the light beam passes through said image pickup lens assembly; a support member for supporting said first and second diaphragm blades for rectilinear movement thereof, and; a diaphragm blade interlocking member supported for rotation relative to said support member and adapted to allow said first diaphragm blade to move rectilinearly in a first direction while permitting said second diaphragm blade to move rectilinearly in a second direction different from said first direction.

In the lens assembly, said diaphragm blade interlocking member has a center of rotation located within an aperture area defined by said first and second diaphragm blade openings at full aperture. Again, said diaphragm blade interlocking member can have a center of rotation located on an optical axis of lens system forming said image pickup lens assembly. With this arrangement, it is possible that the operating or driving portion for operating the diaphragm device does not extend beyond the contour of the lens barrel.

The present invention furthermore provides a diaphragm device including rectilinearly movable diaphragm blades, comprising: a first diaphragm blade having an opening defining a first aperture operable on one hand to adjust an amount of light at which the light beam passes through said image pickup lens assembly; a second diaphragm blade having an opening defining a second aperture operable on the other hand to adjust an amount of light at which the light beam passes through said image pickup lens assembly; a support member for supporting said first and second diaphragm blades for rectilinear movement thereof, and; a diaphragm blade interlocking member supported for rotation relative to said support member and adapted to allow said first diaphragm blade to move rectilinearly in a first direction while permitting said second diaphragm blade to move rectilinearly in a second direction different from said first direction.

In the diaphragm device of the present invention, the diaphragm blade interlocking member has a center of rotation located within an aperture area defined by said first and second diaphragm blade openings at full aperture. Again, said diaphragm blade interlocking member can have a center of rotation located on an optical axis of lens system forming said image pickup lens assembly. With this arrangement, it is possible to downsize the operating or driving portion for operating the diaphragm device.

Preferably, said diaphragm blade interlocking member has an opening through which the light beam from the subject passes and said support member has a guide portion for supporting said diaphragm blade interlocking member so that it can rotate relative to the support member, said diaphragm blade interlocking member being adapted to be located within the support member in such a manner that the opening of the diaphragm blade interlocking member is aligned with the guide portion of the support member. Advantageously, the support member can include a rotation stop arranged in such a manner that the diaphragm blade interlocking member can rotate relative to the support member through a predetermined angle. Preferably, the diaphragm blade interlocking member comprises an opening through which the light beam from the subject passes, an interlocking pin operable to cause said first diaphragm blade to move rectilinearly in said first direction, and an interlocking pin operable to cause said second diaphragm to move rectilinearly in said second direction different from said first direction, said first and second interlocking pins being arranged to be in point of symmetry relationship relative to each other with respect to a center of the opening of the diaphragm blade interlocking member.

It is also preferable that said diaphragm blade interlocking member comprises a control portion operable to rectilinearly move said first and second diaphragm blades in the opposite directions relative to each other at a time so as to change a F-number, said first and second interlocking pins being positioned on a line perpendicular to a line connecting said center of the opening of the diaphragm blade interlocking member and said control portion.

The image pickup lens assembly may include a lens barrel having an inlet portion for receiving said diaphragm device, said diaphragm device being adapted to be disposed in said inlet portion of said lens barrel. Advantageously, the center of rotation of said diaphragm blade interlocking member is in coincidence with the center of the aperture area defined by said first and second diaphragm blade openings at full aperture.

Preferably, said diaphragm blade interlocking member has an engaging portion for fitting the diaphragm blade interlocking member into said support member and supporting the same thereagainst, said support member has also a receiver portion for receiving and supporting a portion of said diaphragm blade interlocking member, said engaging portion of said diaphragm blade interlocking member being adapted to be fitted into said receiver portion of said support member.

Preferably, said diaphragm blade interlocking member comprises an opening through which the light beam from the subject passes and an operating portion operable to rectilinearly move said first and second diaphragm blades in the opposite directions relative to each other at a time so as to change a F-number, said engaging portion of said diaphragm blade interlocking member and said operating portion of said diaphragm blade interlocking member being arranged to be in point of symmetry relationship relative to each other with respect to a center of the opening of the diaphragm blade interlocking member.

Thus, the present invention can realize a lens assembly comprising a diaphragm device including an operating (driving) portion which does not extend beyond the contour of the lens barrel and a surveillance camera comprising such a lens assembly.

According to the features of the present invention, it is possible to make the entire diaphragm device compact and also as a unit. Thus, the diaphragm device can be post-installed into the lens barrel.

According to the present invention, the manually operated diaphragm device can be converted into an automated diaphragm device by unitizing the manually operated diaphragm device and mounting a galvanometer therein.

### BRIEF DESCRIPTION OF THE DRAWINGS

FIG. 1 is a schematic cross-sectional view of a surveillance camera according to the first embodiment of the present invention.

FIG. 2 is a front view of a diaphragm device for use in the surveillance camera according to the first embodiment of the present invention wherein the diaphragm device is at full aperture.

FIG. 3 is an exploded perspective view showing various components of the diaphragm device in the surveillance camera according to the first embodiment of the present invention.

FIG. 4 is an exploded perspective view illustrating a process of assembling the diaphragm device in the surveillance camera according to the first embodiment of the present invention.

FIG. 5 is a perspective view of a lens barrel in the surveillance camera according to the first embodiment of the present invention.

FIG. 6 is an exploded perspective view illustrating a process of assembling the lens barrel in the surveillance camera according to the first embodiment of the present invention.

FIG. 7 is a front view of the diaphragm device for use in the surveillance camera according to the first embodiment of the present invention wherein the diaphragm device is at an intermediate aperture between full and closed apertures.

FIG. 8 is a front view of the diaphragm device for use in the surveillance camera according to the first embodiment of the present invention wherein the diaphragm device is at closed aperture.

FIG. 9 is a front view of a diaphragm device according to the second embodiment of the present invention wherein diaphragm device is at full aperture.

### DETAILED DESCRIPTION OF THE PREFERRED EMBODIMENTS

Several preferred embodiments of the present invention will now be described with reference to the accompanying drawings. The preferred embodiments of the present invention will be described in connection with a surveillance camera which comprises a lens assembly including a diaphragm device with rectilinearly movable diaphragm blades. Rather, the diaphragm device according to the present invention can also be used with any other type of camera system including still cameras, video cameras or digital cameras. Also, the diaphragm of the present invention can be used with a variety of other lens assemblies such as OHP projectors, liquid crystal projectors, light projectors and cinema projectors.

### 1. First Embodiment

One embodiment according to the present invention will first be described.

1-1. Structure of Surveillance Camera

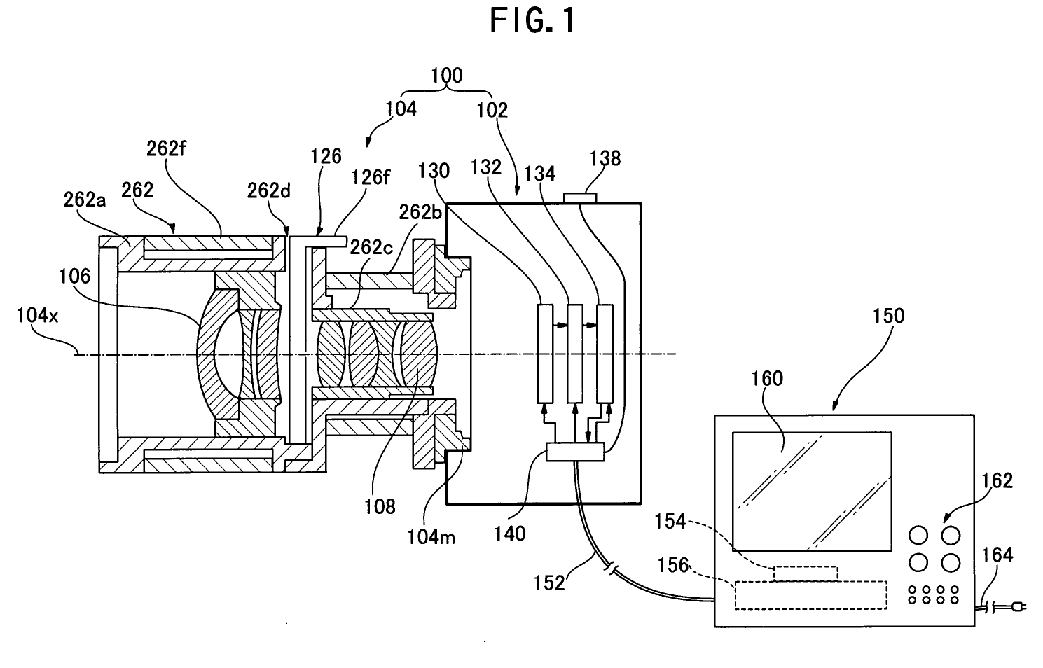

Referring now to FIG. 1, a surveillance camera 100 according to the present invention comprises a main unit (a camera main unit) 102 for sensing and recording an image formed by a light beam from a subject and an image pickup lens 104 for focusing the light beam from the subject. The image pickup lens 104 is detachably mounted on a housing of the main unit 102 through a lens mount 104m. Alternatively, the image pickup lens 104 may be fixedly attached to the housing of the camera main unit 102. The image pickup lens 104 has an optical axis 104x, a front-group optical system 106, a rear-group optical system 108 and a diaphragm device 126. The rear-group optical system 108 constitutes a focusing lens system which is movable along the optical axis 104x of the image pickup lens assembly. Alternatively, both the front-group and rear-group optical systems 106, 108 may be are arranged for movement in such a manner to constitute a focusing lens system.

The image pickup lens 104 includes a barrel body 262. The barrel body 262 comprises a first barrel portion 262a, a second barrel portion 262b, a lens frame 262c supporting the rear-group optical system 108, a diaphragm receiving or inlet portion 262d, and a focusing control ring 262f The focusing control ring 262f can be rotated to move the rear-group optical system 108. Alternatively, the focusing control ring 262f may be arranged for rotation in such a manner to move both the front-group and rear-group optical systems 106, 108. The front-group and rear-group optical systems 106, 108 may be supported by such a known supporting structure as described, for example, in the Document 1.

The diaphragm device 126 is inserted into the inlet portion 262d of the lens barrel in a direction perpendicular to the optical axis 104x of the image pickup lens assembly. The diaphragm device 126 is disposed within the barrel body 262 so that the central axis of the diaphragm device 126 will be in coincident with that of the barrel body 262.

The camera main unit 102 includes a solid-state image sensor 130 for converting the image of the subject formed by the image pickup lens 104 into electrical signals, an electrical signal processing unit 132 for processing the electrical signals for the image of the subject that have been outputted from the solid-state image sensor 130, an image recording signal generating unit 134 for outputting a signal used to record the electrical signals for the image of the subject that have been processed by the electrical signal processing unit 132, a switch 138 used to operate the surveillance camera 100, an operation control unit 140 for controlling the operation of the surveillance camera 100 and so on. The solid-state image sensor 130 may comprises CCD or the like. Each of the electrical signal processing unit 132, image recording signal generating unit 134 and operation control unit 140 may comprise MOS-IC, PLA-IC or the like.

An image recording device 150 is provided separately from the camera main unit 102. The image recording device 150 may be comprised of a video tape recorder, for example. The image recording device 150 is connected with the camera main unit 102 through a connecting cable 152. The connecting cable 152 is adapted to supply a power to the camera main unit 102 via the image recording device 150 and also to send a signal to the operation control unit 140 via the image recording device 150, such a signal being used to control the surveillance camera 100. The connecting cable 152 is can be routed to send the electrical signals for the image of the subject to the image recording device 150 after these signals have been outputted from the image recording signal generating unit 134 in the camera main unit 102.

The image recording device 150 comprises a recording unit 154 for receiving the electrical signals for the image of the subject fed from the camera main unit 102 and performing a process for recording the image of the subject, and a recording medium 156 for recording the image of the subject in response to the actuation of the recording unit 154. The recording medium 156 may be in the form of a VTR tape or may be formed by an RAM card, a flexible disk, a Laser Disk, CD-R, CD-RW, DVD-RAM, DVD-RW or the like. The image recording device 150 comprises an image display section 160 for displaying the image of the subject fed from the surveillance camera 100, a switch 162 for actuating the image recording device 150 and a power supply cable 164 connecting the image recording device 150 to a source of power. The source of power for the image recording device 150 may be in the form of either of an external alternating-current power supply, an external battery or an internal battery which is located with the image recording device 150. The recording medium may be located in the camera main unit 102. Where appropriate, any power source such as a battery may be disposed in the camera main unit 102. Where appropriate, any camera display portion (not shown) for displaying the image of the subject may be provided in the camera main unit 102.

1-2. Structure of Diaphragm Device

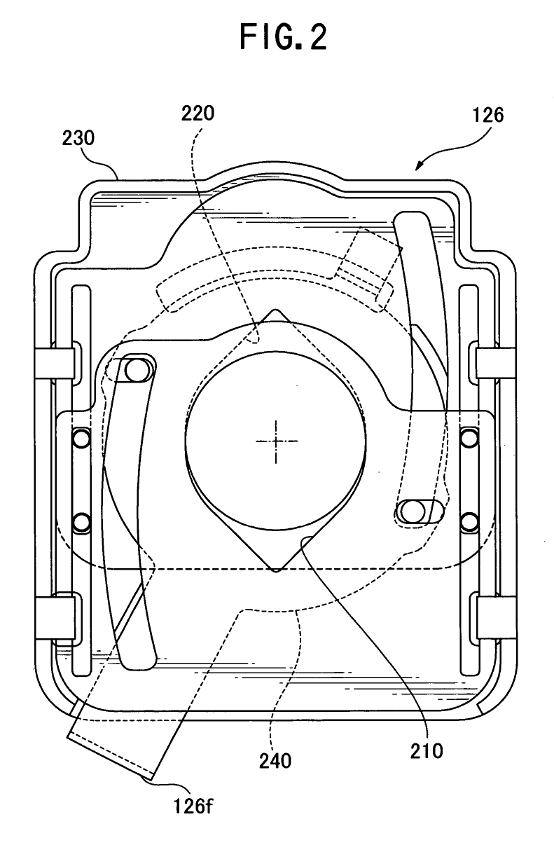

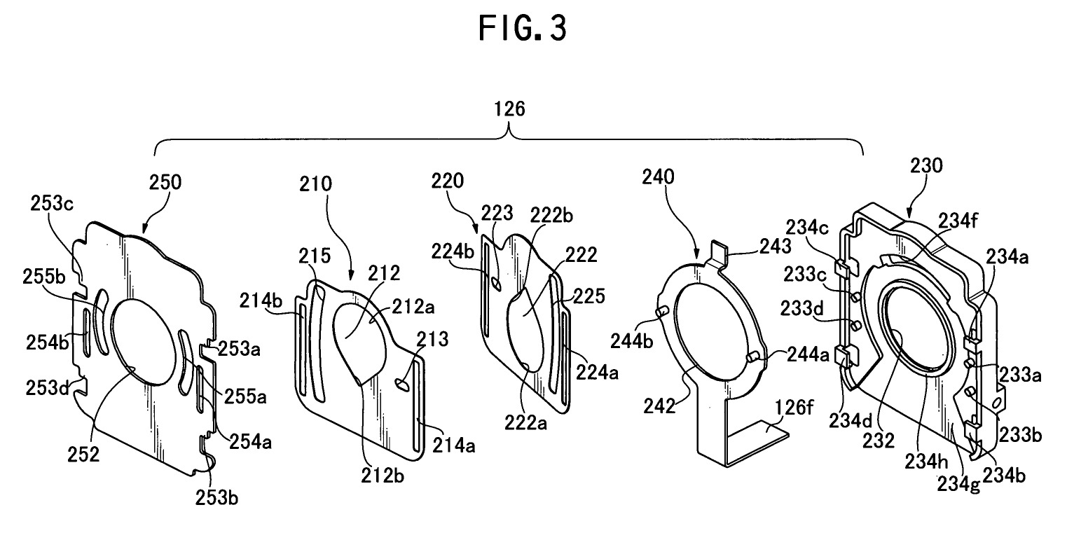

The structure of the diaphragm device according to the first embodiment of the present invention will be described in connection with the surveillance camera 100. Referring to FIGS. 2 and 3, the diaphragm device 126 comprises a first diaphragm blade or upper diaphragm blade 210, a second diaphragm blade or lower diaphragm blade 220, a support member or a support frame 230 supporting the upper and lower diaphragm blades 210, 220 for linear movement thereof, a diaphragm blade interlocking member or blade interlocking plate 240 rotatably supported relative to the support frame 230, and a holding member or fixing plate 250 for holding the upper and lower diaphragm blades 210, 220 against the support frame 230. The upper diaphragm blade 210 is supported against the support frame 230 so that the upper diaphragm blade 210 will be located at its uppermost position at minimum aperture (in other words, at the aperture through which a minimum amount of the light beam passes) and at its lowermost position at full or maximum aperture (in other words, at the aperture through which a maximum amount of the light beam passes). On the contrary, the lower diaphragm blade 220 is supported against the support frame 230 so that the lower diaphragm blade 220 will be located at its lowermost position at minimum aperture and at its uppermost position at full or maximum aperture. In other words, the upper diaphragm blade 210 is rectilinearly moved in the downward direction while the lower diaphragm blade 220 is rectilinearly moved in the upward direction, as the aperture is changed from its minimal level to its full or maximum level.

The support frame 230 has an opening 232 through which the light beam from the subject is permitted to pass, pins 233a-233d for guiding the upper and lower diaphragm blades 210, 220 for linear movement thereof, mount portions 234a-234d for mounting the fixing plate 250, a blade interlocking plate receiving portion 234f for incorporating and supporting part of the blade interlocking plate 240, a blade interlocking plate positioning portion 234g for rotatably positioning the blade interlocking plate 240, and a blade interlocking plate guiding portion 234h for rotatably guiding the blade interlocking plate 240. The support frame opening 232 may preferably be circular. The blade interlocking plate guiding portion 234h may preferably be formed into a ring-shaped band (or an annular projection).

The upper diaphragm blade 210 has a first aperture or upper blade opening 212 for adjusting an amount of light at which the light beam from the subject passes therethrough, an upper blade interlocking slot 213 for receiving the upper blade interlocking pin 244a, a first upper blade guide slot 214a for receiving the blade guide pins 233a and 233b in the support frame 230 to guide the upper diaphragm blade 210 for linear movement thereof, a second upper blade guide slot 214b for receiving the blade guide pins 233c and 233d in the support frame 230 to guide the upper diaphragm blade 210 for linear movement thereof, and a lower blade interlocking pin relief hole 215 for receiving a lower blade interlocking pin 244b. The upper blade opening 212 includes an upper part 212a of substantially semicircular configuration and a lower part 212b coupled with the bottom of the upper part 212a and having a right-angled bottom which is formed by two tangential lines relative to the circle in the upper part 212a. The upper blade interlocking slot 213 has an elongated configuration with its central axis extending in the horizontal direction. Each of the first and second upper blade guide slots 214a, 214b has an elongated configuration with its respective central axis extending in the vertical direction. It is preferred that the shapes of the first and second upper blade guide slots 214a, 214b are identical with each other. The upper blade interlocking slot 213 is positioned on the right of the upper blade opening 212 as viewed from the direction in which the fixing plate 250 is disposed.

The lower diaphragm blade 220 has a second aperture or lower blade opening 222 for adjusting an amount of light at which the light beam from the subject passes therethrough, a lower blade interlocking slot 223 for receiving the lower blade interlocking pin 244b, a first lower blade guide slot 224a for receiving the blade guide pins 233a and 233b in the support frame 230 to guide the lower diaphragm blade 220 for linear movement, a second lower blade guide slot 214b for receiving the blade guide pins 233c and 233d in the support frame 230 to guide the lower diaphragm blade 220 for linear movement thereof, and an upper blade interlocking pin relief hole 225 for receiving the upper blade interlocking pin 244a. The lower blade opening 222 includes a lower part 222a of substantially semi-circular configuration and an upper part 222b coupled with the top of the lower part 222a and having a right-angled top which is formed by two tangents to the circle in the lower part 222a. It is preferred that the lower and upper blade openings 222, 212 are in point of symmetry relationship relative to each other with respect to the center of the lower part 222a. The lower blade interlocking slot 223 has an elongated configuration with its central axis extending in the horizontal direction.

Each of the first and second lower blade guide slots 224a, 224b has an elongated configuration with its respective central axis extending in the vertical direction. It is preferred that the shapes of the first and second lower blade guide slots 224a, 224b are identical with each other. The lower blade interlocking slot 223 is positioned on the left of the lower blade opening 222 as viewed from the direction in which the fixing plate 250 is disposed. Alternatively, the upper blade interlocking slot 213 may be positioned on the left of the upper blade opening 222 and on the right of the lower blade interlocking slot 223 as viewed from the direction in which the fixing plate 250 is disposed. In other words, the lower blade interlocking slot 223 may be positioned opposite to the upper blade interlocking hole 213 about the center of the lower blade opening 222 as viewed from the direction in which the fixing plate 250 is disposed.

The blade interlocking plate 240 is arranged to move the upper diaphragm blade 210 rectilinearly in the first direction and also to move the lower diaphragm blade 220 rectilinearly in the second direction opposite to the first direction when the blade interlocking plate 240 is rotated through a predetermined angle. The blade interlocking plate 240 is arranged to move the upper diaphragm blade 210 rectilinearly in the downward direction and at the same time to move the lower diaphragm blade 220 rectilinearly in the upward direction when the blade interlocking plate 240 is rotated clockwise as viewed from the direction in which the fixing plate 250 is disposed. The blade interlocking plate 240 is also arranged to move the upper diaphragm blade 210 rectilinearly in the upward direction and at the same time to move the lower diaphragm blade 220 rectilinearly in the downward direction when the blade interlocking plate 240 is rotated counter-clockwise as viewed from the direction in which the fixing plate 250 is disposed.

The blade interlocking plate 240 has a blade interlocking plate opening 242 permitting the passage of the light beam from the subject, a blade interlocking plate hooking or engaging portion 243 for fitting the blade interlocking plate 240 into the support frame 230 and supporting the same thereagainst, an upper blade interlocking pin 244a used to moving the upper diaphragm blade 210 rectilinearly, a lower blade interlocking pin 244b used to move the lower diaphragm blade 220 rectilinearly, and an operating portion 126f for simultaneously moving the upper and lower diaphragm blades 210, 220 rectilinearly in the opposite directions to change the F-number. It is preferred that the upper and lower blade interlocking pins 244a, 244b are in point of symmetry relationship relative to each other with respect to the center of the blade interlocking plate opening 242. If the blade interlocking plate 240 is fitted into the blade interlocking plate guiding portion 234h of the support frame 230 in such a manner that the opening 242 of the diaphragm blade interlocking plate is aligned with the guide portion 234h, the blade interlocking plate 240 can be rotated relative to the support frame 230.

Preferably, the blade interlocking plate opening 242 has a size equal to or larger than that of the upper part 212a in the upper blade opening 212. It is also preferred that the blade interlocking plate opening 242 has a size equal to or larger than that of the lower part 222a in the lower blade opening 222.

The fixing plate 250 has an opening 252 permitting the passage of the light beam from the subject, fixing plate mounting portions 253a-253d for mounting the fixing plate 250 in the support frame 230, a blade guide pin relief hole 254a for receiving the blade guide pins 233a and 233b, a blade guide pin relief hole 254b for receiving the blade guide pins 233c and 233d, an upper blade interlocking pin relief hole 255a for receiving the upper blade interlocking pin 244a, and a lower blade interlocking pin relief hole 255b for receiving the lower blade interlocking pin 244b.

The fixing plate opening 252 is preferably circular. Preferably, the fixing plate opening 252 has a size equal to or larger than that of the upper part 212a in the upper blade opening 212. It is also preferred that the fixing plate opening 242 has a size equal to or larger than that of the lower part 222a in the lower blade opening 222.

The upper blade interlocking pin relief hole 255a can have an arcuate configuration having its central axis extending arcuately. The lower blade interlocking pin relief hole 255b can also have an arcuate configuration having its central axis extending arcuately. Preferably, the upper and lower blade interlocking pin relief holes 255a, 255b is identical in shape with each other. It is also preferred that the upper and lower blade interlocking pin relief holes 255a, 255b are in point of symmetry relationship relative to each other with respect to the center of the fixing plate opening 252. Preferably, the blade guide pin relief hole 254a has an elongated configuration with its central axis extending in the vertical direction. Alternatively, the blade guide pin relief hole 254a may be comprised of a first circular hole for receiving the blade guide pin 233a and a second circular hole for receiving the blade guide pin 233b. Preferably, the blade guide pin relief hole 254b has an elongated configuration with its central axis extending in the vertical direction. Alternatively, the blade guide pin relief hole 254b may be comprised of a third circular hole for receiving the blade guide pin 233c and a fourth circular hole for receiving the blade guide pin 233d.

1-3. Assembling Process of Diaphragm Device

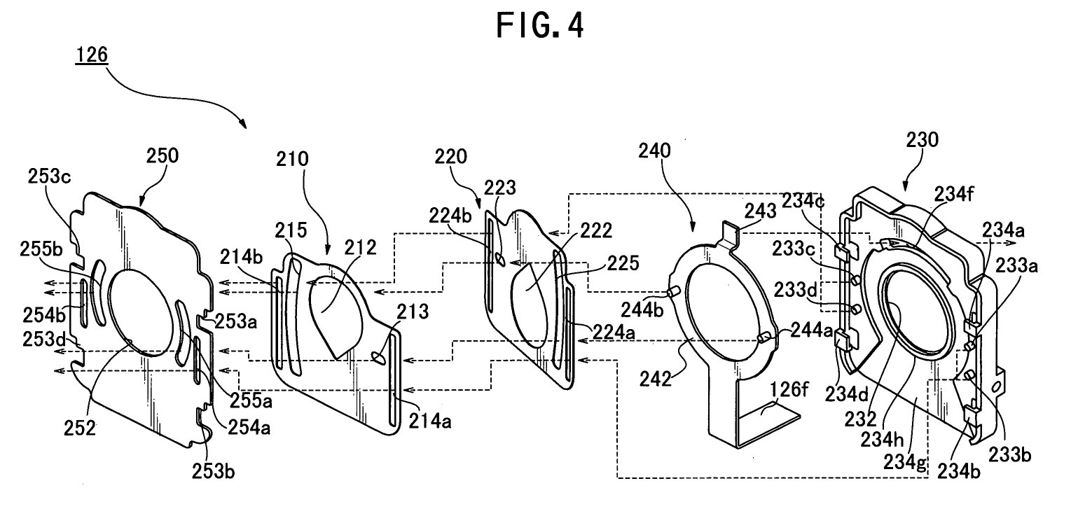

The assembling process of the diaphragm device 126 according to the first embodiment of the present invention will be described below. Referring to FIG. 4, the hooking portion 243 of the blade interlocking plate 240 in the diaphragm device 126 is firstly assembled into the blade interlocking plate receiving portion 234f of the support frame 230. The blade interlocking plate 240 is secondly assembled into the blade interlocking plate guiding portion 234h of the support frame 230. In other words, the blade interlocking plate 240 is incorporated into the support frame 230 so that the blade interlocking plate 240 can be rotated about the center of the blade interlocking plate guiding portion 234h (i.e., the center of the blade interlocking plate opening 242).

Subsequently, the lower diaphragm blade 220 is placed on the blade interlocking plate 240. The lower blade interlocking slot 223 receives the lower blade interlocking pin 244b. The first lower blade guide hole 224a receives the blade guide pins 233a and 233b in the support frame 230, and guides the lower diaphragm blade 220 so that it can be rectilinearly moved relative to the support frame 230 in the vertical direction. The second lower blade guide hole 224b also receives the blade guide pins 233c and 233d in the support frame 230, and guides the lower diaphragm blade 220 so that it can be rectilinearly moved relative to the support frame 230 in the vertical direction.

The upper diaphragm blade 210 is then placed on the lower diaphragm blade 220. The upper blade interlocking slot 213 receives the upper blade interlocking pin 244a. The first upper blade guide hole 214a receives the blade guide pins 233a and 233b in the support frame 230, and guides the upper diaphragm blade 220 so that it can be rectilinearly moved relative to the support frame 230 in the vertical direction. The second upper blade guide slot 214b receives the blade guide pins 233c and 233d in the support frame 230, and guides the upper diaphragm blade 220 so that it can be rectilinearly moved relative to the support frame 230 in the vertical direction.

Subsequently, the fixing plate 250 is placed on the upper diaphragm blade 210. The blade guide pins 233a and 233b extend through the blade guide pin relief hole 254a. The blade guide pins 233c and 233d extend through the blade guide pin relief hole 254b. The upper blade interlocking pin 244a extends through the upper blade interlocking pin relief hole 255a. The lower blade interlocking pin 244b extends through the lower blade interlocking pin relief hole 255b. The fixing plate mounting portions 253a-253d are engaged inwardly by the fixing plate mounting portions 234a-234d, respectively, and consequently the fixing plate 250 is attached to the support frame 230.

When the diaphragm device 126 has been completely assembled, and if the F-number is in its full-open state, the center of the circular part in the upper blade opening 212 coincides with the circular part in the lower blade opening 222. When the diaphragm device 126 has been completely assembled, the center of the supporting frame opening 232 coincides with the center of the fixing plate opening 252, with the center of the circular part in the upper blade opening 212 when the F-number is in its full-open state, and with the center of the circular part in the lower blade opening 222 when the F-number is in its full-open state.

1-4. Assembling Process of Diaphragm Device into Lens Barrel

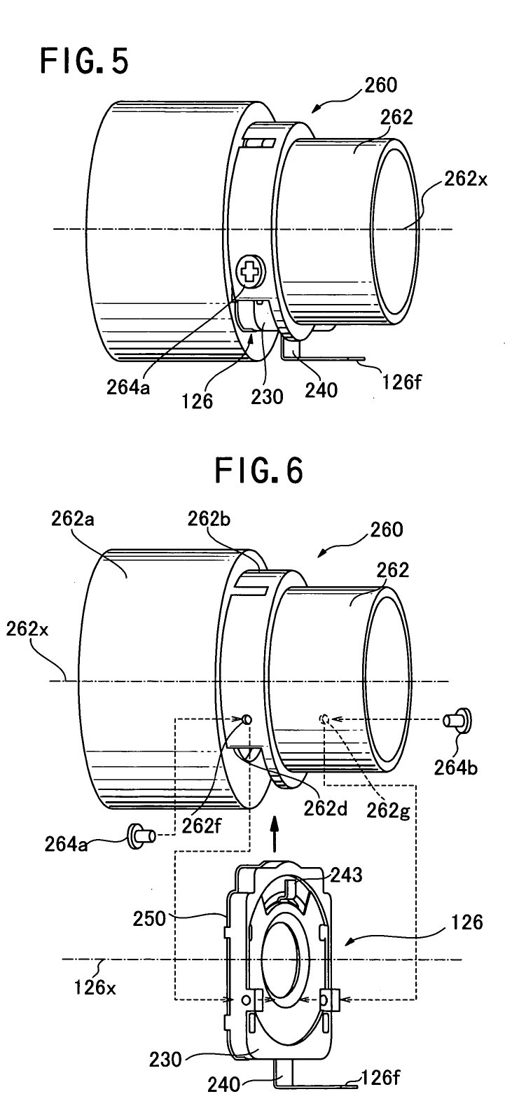

The assembling process of the diaphragm device 126 according to the first embodiment of the present invention into the lens barrel 260 will be described below. Referring to FIGS. 5 and 6, the lens barrel 260 includes a lens barrel body 262. The lens barrel body 262 includes a first barrel portion 262a, a second barrel portion 262b, a diaphragm receiving or inlet portion 262d formed below the second barrel portion 262b, and diaphragm mounting parts 262f and 262g formed in the side of the second barrel portion 262b. The diaphragm device 126 is inserted into the inlet portion 262d of the lens barrel from the lower part of the lens barrel body 262. Alternatively, the diaphragm device 126 may be inserted into the inlet portion 262d from the upper part of the lens barrel body 262 by changing the direction in which the lens barrel body 262 is set.

The diaphragm device 126 is mounted in the lens barrel body 262 so that the central axis 126x of the lens barrel body 262 will coincide with the central axis 126x of the diaphragm device 126. In such a state, the diaphragm device 126 may fixedly be mounted in the lens barrel body 262 by screwing setscrews 264a and 264b into the diaphragm mounting parts 262f and 262g, respectively.

Subsequently, the lens barrel 260 is assembled into the image pickup lens 104 after the diaphragm device 126 has been installed into the lens barrel 260. When the assembled diaphragm device 126 is to be incorporated into the image pickup lens 104, the center of the supporting frame opening 232 is placed on the optical axis 104x of the lens system 106.

In the diaphragm device of the present invention, the rotation center of the blade interlocking plate 240 is located within an aperture area defined by the upper and lower blade openings 212, 222 at full or maximum aperture. According to the present invention, it is more preferred that the rotation center of the blade interlocking plate 240 is positioned on the optical axis 104x of the lens system 106 forming the image pickup lens 104. It is further preferred that the rotation center of the blade interlocking plate 240 is in coincidence with the center of the aperture area at full aperture or the opening of the support frame 230. In such an arrangement, the camera can be realized which has the lens system with the diaphragm device whose operating or driving portion for driving the diaphragm device (or the operating portion for operating the diaphragm device) do not extend beyond the contour of the lens barrel.

1-5. Operation of Surveillance Camera

Operation of the surveillance camera 100 according to the first embodiment of the present invention will be described below. Referring to FIG. 1, a user can set the necessary F-number by manually operating the operating portion 126f in the diaphragm device 126 to rotate the blade interlocking plate 240 by the necessary angle so that the upper diaphragm blade 210 is rectilinearly moved in the downward direction while at the same time the lower diaphragm blade 220 is rectilinearly moved in the upward direction.

In other words, the user operates the diaphragm device 126 to provide a F-number appropriate for taking an image. For example, if the F-number appropriate for taking the image is that at full aperture, the user may manually operate the operating portion 126f in the diaphragm device 126 to rotate the blade interlocking plate 240 clockwise as viewed from the direction in which the fixing plate 250 is positioned through an angle necessary for changing F-number from at closed aperture to at full or maximum aperture. As a result, the upper diaphragm blade 210 will be moved rectilinearly in the downward direction while at the same time the lower diaphragm blade 220 will be rectilinearly in the upward direction. When the F-number is set at full or maximum aperture, as shown in FIG. 2, the center of the circular upper part 212a in the upper blade opening 212 coincides with the center of the circular lower part 222a in the lower blade opening 222 and also the centers of the circular upper and lower parts 212a, 222a coincide with the optical axis 104x of the image pickup lens 104.

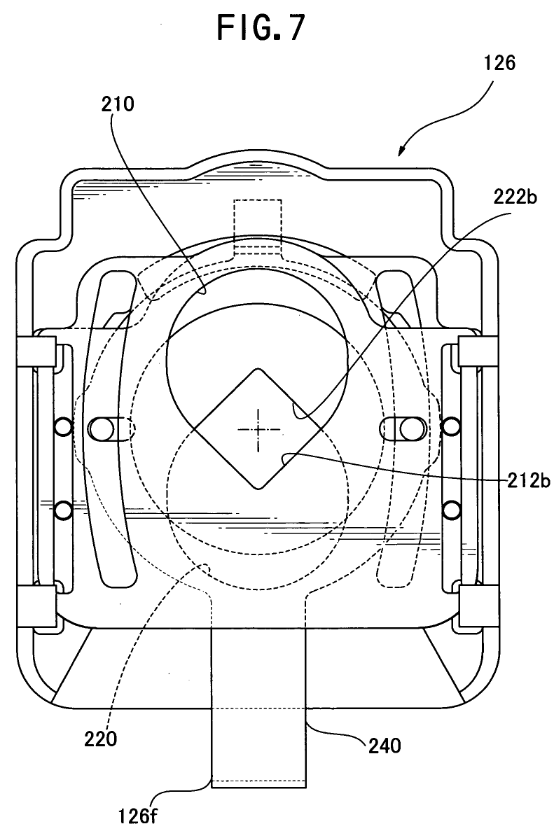

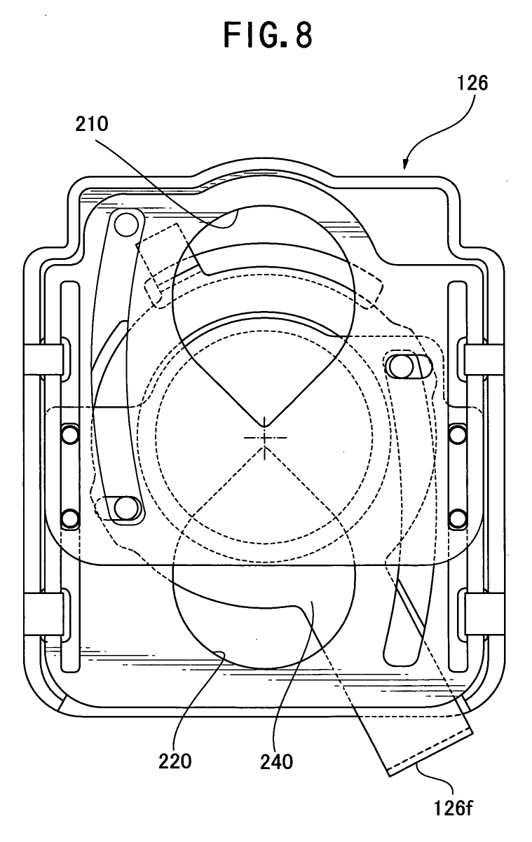

If F-number appropriate for taking the image is at an intermediate aperture (in other words, at the aperture through which an intermediate amount of the light beam passes), the user may manually operate the operating portion 126f in the diaphragm device 126 to rotate the blade interlocking plate 240 clockwise as viewed from the direction in which the fixing plate 250 is positioned through an angle necessary for changing the F-number from at closed aperture to at an intermediate aperture. As a result, the upper diaphragm blade 210 will be moved rectilinearly in the downward direction while at the same time the lower diaphragm blade 220 will be rectilinearly in the upward direction. When the F-number is set at the intermediate aperture, as shown in FIG. 7, the lower part 212b of the upper blade opening 212 forms a substantially square shape with the lower part 222a of the lower blade opening 222 and also provides a point of intersection between the diagonal lines of said square coinciding with the optical axis 104x of the image pickup lens 104. After the diaphragm device 126 has been set, the user operates the image recording device 150 to send a signal for controlling the operation of the surveillance camera 100 thereto, thereby actuating a solid-state image sensor 130. The solid-state image sensor 130 receives the light beam from the subject. The image recording signal generating unit 134 outputs a signal used to record information relating to the image of the subject, based on the signal outputted by the solid-state image sensor 130. The operation control unit 140 sends the electrical signals relating to the image of the subject to the image recording device 150, based on the signal outputted from the image recording signal generating unit 134.

The recording unit 154 of the image recording device 150 receives the electrical signals relating to the image of the subject fed from the camera main unit 102, resulting in initiation of the recording of the image of the subject. The image of the subject is recorded onto the recording medium 156 immediately when the recording unit 154 in the image recording device 150 is actuated. The image display unit 160 in the image recording device 150 displays the image of the subject fed from the surveillance camera 100.

In the diaphragm device of the present invention, the user may manually operate the operating portion 126f in the diaphragm device 126 to adjust an angular displacement of the blade interlocking plate 240, thereby setting F-number between at full or maximum aperture and at such an intermediate aperture as shown in FIG. 7. In the diaphragm device of the present invention, any aperture which is narrower than the intermediate aperture as shown in Fig. may also be provided by adjusting the angular displacement of the blade interlocking plate 240 (in other words, a less amount of light at which the light beam passes therethrough is provided). The adjustment of the angular displacement of the blade interlocking plate 240 may manually be performed by means of the operating portion 126 operated by the user.

### 2. Second Embodiment

Second embodiment of the diaphragm device according to the present invention will be described below. The following description refers mainly to the features of a diaphragm device according to the second embodiment of the present invention which are different from those of the first embodiment. Therefore, similar features will not further be described herein, but should be supposed from the description of the first embodiment.

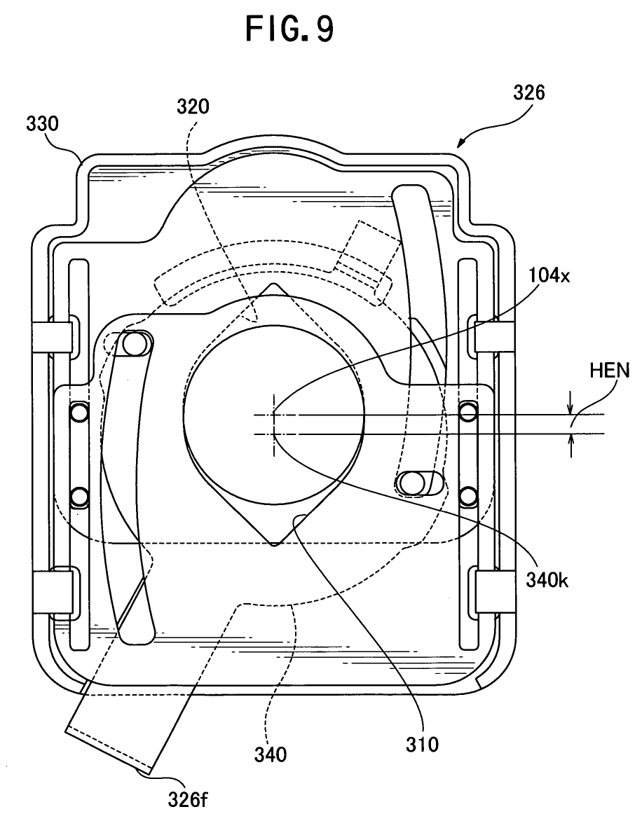

Referring to FIG. 9, the rotation center 340k of a blade interlocking plate 340 in a diaphragm device 326 according to the second embodiment of the present invention is positioned in the inner area of the full-open aperture formed by the upper blade opening of the upper diaphragm blade 310 and the lower blade opening of the lower diaphragm blade 320 when the aperture is in its full-open state. In the diaphragm device according to the second embodiment of the present invention, furthermore, the rotation center 340k of the blade interlocking plate 340 is spaced apart from the optical axis 104x of the lens system 106 forming the image pickup lens 104 by a distance HEN. In the diaphragm device according to the second embodiment of the present invention, the relief holes are different in shape from those of the diaphragm device according to the first embodiment of the present invention.

The user may manually operate an operating portion 326f of the diaphragm device 326 to rotate a blade interlocking plate 340 through a desired angle. As a result, an upper diaphragm blade 310 will be moved rectilinearly in the downward direction while at the same time a lower diaphragm blade 320 will be rectilinearly in the upward direction, thereby setting any necessary F-number. In such an arrangement, a surveillance camera with a lens assembly including a diaphragm device of reduced dimensions can be realized.

### LIST OF REFERENCE NUMERALS

100 surveillance camera
102 camera main unit
104 image pickup lens
106 front-group optical system
108 rear-group optical system
126 diaphragm device
130 solid-state image sensor
210 upper diaphragm blade
220 lower diaphragm blade
230 support frame
240 blade interlocking plate
250 fixing plate
310 upper diaphragm blade
320 lower diaphragm blade
326 diaphragm device
340 blade interlocking plate

What is claimed is:

1. A surveillance camera comprising a diaphragm device including rectilinearly movable diaphragm blades, comprising:
an image pickup lens assembly for focusing a light beam originating from subject;
a camera main unit for recording the light beam from the subject passing through said image pickup lens assembly;
the diaphragm device for adjusting an amount of light at which the light beam passes through said image pickup lens assembly, said diaphragm device comprising:
a first diaphragm blade having an opening defining a first aperture operable on one hand to adjust an amount of light at which the light beam passes through said image pickup lens assembly;
a second diaphragm blade having an opening defining a second aperture operable on the other hand to adjust an amount of light at which the light beam passes through said image pickup lens assembly;
a support member for supporting said first and second diaphragm blades for rectilinear movement thereof, and;
a diaphragm blade interlocking member supported for rotation relative to said support member and adapted to allow said first diaphragm blade to move rectilinearly in a first direction while permitting said second diaphragm blade to move rectilinearly in a second direction different from said first direction;
said diaphragm blade interlocking member having a center of rotation located within an aperture area defined by said first and second diaphragm blade openings at full aperture.

2. A surveillance camera according to claim 1, wherein said diaphragm blade interlocking member has a center of rotation located on an optical axis of lens system forming said image pickup lens assembly.

3. A surveillance camera according to claim 1, wherein said diaphragm blade interlocking member has an opening through which the light beam from the subject passes and said support member has a guide portion for supporting said diaphragm blade interlocking member so that it can rotate relative to the support member, said diaphragm blade interlocking member being adapted to be located within the support member in such a manner that the opening of the diaphragm blade interlocking member is aligned with the guide portion of the support member.

4. A surveillance camera according to claim 3, wherein said support member includes a rotation stop arranged in such a manner that the diaphragm blade interlocking member can rotate relative to the support member through a predetermined angle.

5. A surveillance camera according to claim 1, wherein said diaphragm blade interlocking member comprises an opening through which the light beam from the subject passes, an interlocking pin operable to cause said first diaphragm blade to move rectilinearly in said first direction, and an interlocking pin operable to cause said second diaphragm to move rectilinearly in said second direction different from said first direction, said first and second interlocking pins being arranged to be in point of symmetry relationship relative to each other with respect to a center of the opening of the diaphragm blade interlocking member.

6. A surveillance camera according to claim 5, wherein said diaphragm blade interlocking member comprises a control portion operable to rectilinearly move said first and second diaphragm blades in the opposite directions relative to each other at a time so as to change a F-number, said first and second interlocking pins being positioned on a line perpendicular to a line connecting said center of the opening of the diaphragm blade interlocking member and said control portion.

7. A surveillance camera according to claim 1, wherein said image pickup lens assembly includes a lens barrel having an inlet portion for receiving said diaphragm device, said diaphragm device being adapted to be disposed in said inlet portion of said lens barrel.

8. A surveillance camera according to claim 1, wherein said center of rotation of said diaphragm blade interlocking member is in coincidence with the center of the aperture area defined by said first and second diaphragm blade openings at full aperture.

9. A surveillance camera according to claim 1, wherein said diaphragm blade interlocking member has an engaging portion for fitting the diaphragm blade interlocking member into said support member and supporting the same thereagainst, said support member has also a receiver portion for receiving and supporting a portion of said diaphragm blade interlocking member, said engaging portion of said diaphragm blade interlocking member being adapted to be fitted into said receiver portion of said support member.

10. A surveillance camera according to claim 9, wherein said diaphragm blade interlocking member comprises an opening through which the light beam from the subject passes and an operating portion operable to rectilinearly move said first and second diaphragm blades in the opposite directions relative to each other at a time so as to change a F-number, said engaging portion of said diaphragm blade interlocking member and said operating portion of said diaphragm blade interlocking member being arranged to be in point of symmetry relationship relative to each other with respect to a center of the opening of the diaphragm blade interlocking member.

11. A lens assembly including a diaphragm device including rectilinearly movable diaphragm blades, said lens assembly comprising:
a lens system arranged to cause a light beam passing through said lens system to diverge or converge, and;
the diaphragm device for adjusting an amount of light at which the light beam passes through said image pickup lens assembly, said diaphragm device comprising:
a first diaphragm blade having an opening defining a first aperture operable on one hand to adjust an amount of light at which the light beam passes through said image pickup lens assembly;
a second diaphragm blade having an opening defining a second aperture operable on the other hand to adjust an amount of light at which the light beam passes through said image pickup lens assembly;
a support member for supporting said first and second diaphragm blades for rectilinear movement thereof, and;
a diaphragm blade interlocking member supported for rotation relative to said support member and adapted to allow said first diaphragm blade to move rectilinearly in a first direction while permitting said second diaphragm blade to move rectilinearly in a second direction different from said first direction;
said diaphragm blade interlocking member having a center of rotation located within an aperture area defined by said first and second diaphragm blade openings at full aperture.

12. A lens assembly according to claim 11, wherein said diaphragm blade interlocking member has a center of rotation located on an optical axis of said lens system.

13. A lens assembly according to claim 11, wherein said diaphragm blade interlocking member has an opening through which the light beam from the subject passes and said support member has a guide portion for supporting said diaphragm blade interlocking member so that it can rotate relative to the support member, said diaphragm blade interlocking member being adapted to be located within the support member in such a manner that the opening of the diaphragm blade interlocking member is aligned with the guide portion of the support member.

14. A lens assembly according to claim 13, wherein said support member includes a rotation stop arranged in such a manner that the diaphragm blade interlocking member can rotate relative to the support member through a predetermined angle.

15. A lens assembly according to claim 11, wherein said diaphragm blade interlocking member comprises an opening through which the light beam originating from a subject passes, an interlocking pin operable to cause said first diaphragm blade to move rectilinearly in said first direction, and an interlocking pin operable to cause said second diaphragm to move rectilinearly in said second direction different from said first direction, said first and second interlocking pins being arranged to be in point of symmetry relationship relative to each other with respect to a center of the opening of the diaphragm blade interlocking member.

16. A lens assembly according to claim 15, wherein said diaphragm blade interlocking member comprises a control portion operable to rectilinearly move said first and second diaphragm blades in the opposite directions relative to each other at a time so as to change a F-number, said first and second interlocking pins being positioned on a line perpendicular to a line connecting said center of the opening of the diaphragm blade interlocking member and said control portion.

17. A lens assembly according to claim 11, wherein said image pickup lens assembly includes a lens barrel having an inlet portion for receiving said diaphragm device, said diaphragm device being adapted to be disposed in said inlet portion of said lens barrel.

18. A lens assembly according to claim 11, wherein said center of rotation of said diaphragm blade interlocking member is in coincidence with the center of the aperture area defined by said first and second diaphragm blade openings at full aperture.

19. A lens assembly according to claim 11, wherein said diaphragm blade interlocking member has an engaging portion for fitting the diaphragm blade interlocking member into said support member and supporting the same thereagainst, said support member has also a receiver portion for receiving and supporting a portion of said diaphragm blade interlocking member, said engaging portion of said diaphragm blade interlocking member being adapted to be fitted into said receiver portion of said support member.

20. A lens assembly according to claim 19, wherein said diaphragm blade interlocking member comprises an opening through which the light beam from the subject passes and an operating portion operable to rectilinearly move said first and second diaphragm blades in the opposite directions relative to each other at a time so as to change a F-number, said engaging portion of said diaphragm blade interlocking member and said operating portion of said diaphragm blade interlocking member being arranged to be in point of symmetry relationship relative to each other with respect to a center of the opening of the diaphragm blade interlocking member.

21. A diaphragm device including rectilinearly movable diaphragm blades, said diaphragm device comprising:
a first diaphragm blade having an opening defining a first aperture operable on one hand to adjust an amount of light at which the light beam passes through said image pickup lens assembly;
a second diaphragm blade having an opening defining a second aperture operable on the other hand to adjust an amount of light at which the light beam passes through said image pickup lens assembly;
a support member for supporting said first and second diaphragm blades for rectilinear movement thereof, and;
a diaphragm blade interlocking member supported for rotation relative to said support member and adapted to allow said first diaphragm blade to move rectilinearly in a first direction while permitting said second diaphragm blade to move rectilinearly in a second direction different from said first direction;
said diaphragm blade interlocking member having a center of rotation located within an aperture area defined by said first and second diaphragm blade openings at full aperture.

22. A diaphragm device according to claim 21, wherein said center of rotation of said diaphragm blade interlocking member is in coincidence with the center of the aperture area defined by said first and second diaphragm blade openings at full aperture.

23. A diaphragm device according to claim 21, wherein said diaphragm blade interlocking member has an opening through which the light beam from the subject passes and said support member has a guide portion for supporting said diaphragm blade interlocking member so that it can rotate relative to the support member, said diaphragm blade interlocking member being adapted to be located within the support member in such a manner that the opening of the diaphragm blade interlocking member is aligned with the guide portion of the support member.

24. A diaphragm device according to claim 23, wherein said support member includes a rotation stop arranged in such a manner that the diaphragm blade interlocking member can rotate relative to the support member through a predetermined angle.

25. A diaphragm device according to claim 21, wherein said diaphragm blade interlocking member comprises an opening through which the light beam originating from a subject passes, an interlocking pin operable to cause said first diaphragm blade to move rectilinearly in said first direction, and an interlocking pin operable to cause said second diaphragm to move rectilinearly in said second direction different from said first direction, said first and second interlocking pins being arranged to be in point of symmetry relationship relative to each other with respect to a center of the opening of the diaphragm blade interlocking member.

26. A diaphragm device according to claim 25, wherein said diaphragm blade interlocking member comprises a control portion operable to rectilinearly move said first and second diaphragm blades in the opposite directions relative to each other at a time so as to change a F-number, said first and second interlocking pins being positioned on a line perpendicular to a line connecting said center of the opening of the diaphragm blade interlocking member and said control portion.

27. A diaphragm device according to claim 21, wherein said diaphragm device is adapted to be disposed in an inlet portion of a lens barrel.

28. A diaphragm device according to claim 21, wherein said center of rotation of said diaphragm blade interlocking member is in coincidence with the center of the aperture area defined by said first and second diaphragm blade openings at full aperture.

29. A diaphragm device according to claim 21, wherein said diaphragm blade interlocking member has an engaging portion for fitting the diaphragm blade interlocking member into said support member and supporting the same thereagainst, said support member has also a receiver portion for receiving and supporting a portion of said diaphragm blade interlocking member, said engaging portion of said diaphragm blade interlocking member being adapted to be fitted into said receiver portion of said support member.

30. A diaphragm device according to claim 29, wherein said diaphragm blade interlocking member comprises an opening through which the light beam from the subject passes and an operating portion operable to rectilinearly move said first and second diaphragm blades in the opposite directions relative to each other at a time so as to change a F-number, said engaging portion of said diaphragm blade interlocking member and said operating portion of said diaphragm blade interlocking member being arranged to be in point of symmetry relationship relative to each other with respect to a center of the opening of the diaphragm blade interlocking member.
